(19) United States
(12) Patent Application Publication
(10) Pub. No.: US 2026/0303760 A1
(43) Pub. Date: Oct. 1, 2026

(54) STREAMING SYSTEM, STORAGE MEDIUM, AND STREAMING METHOD

(71) Applicant: HONDA MOTOR CO., LTD., Tokyo (JP)

(72) Inventor: Yuta Nishizawa, Tokyo (JP)

(21) Appl. No.: 19/549,422

(22) Filed: Feb. 25, 2026

(30) Foreign Application Priority Data
Mar. 28, 2025 (JP) 2025-056376

(51) Int. Cl. H04N 7/18

(52) U.S. Cl. CPC H04N 7/185

(57) ABSTRACT

A streaming system includes: a streaming unit that streams an image obtained through capturing by a capturing apparatus provided in a vehicle; a display apparatus that is provided in a location other than the vehicle and displays the image streamed by the streaming unit; and a first estimation unit that estimates a first amount of time from when the vehicle starts turning until the vehicle finishes turning, based on information of a surrounding area of the vehicle, wherein the display apparatus displays the first amount of time estimated by the first estimation unit along with the image streamed by the streaming unit.

### INCORPORATION BY REFERENCE

The present application claims priority under 35 U.S.C. § 119 to Japanese Patent Application No. 2025-056376 filed on Mar. 28, 2025. The content of the application is incorporated herein by reference in its entirety.

### BACKGROUND OF THE INVENTION

### Field of the Invention

The present invention relates to a streaming system, a storage medium, and a streaming method.

### Description of the Related Art

In recent years, efforts have been accelerating to provide access to sustainable transportation systems that take into account vulnerable traffic participants such as the elderly, people with disabilities, and children. To this end, efforts are focused on research and development for further improving the safety and convenience of traffic through the development of means of transportation for vulnerable road users. There is a method of viewing a moving image streamed by a streamer of an image (for example, see Japanese Patent Laid-Open No. 2024-039702), without a person in a vulnerable position personally having to enter a mobile body to access a transportation system.

Japanese Patent Laid-Open No. 2024-064361 discloses generating a composite video by processing a video captured by imaging equipment provided in a vehicle, and transmitting the generated composite video to a remote terminal. Japanese Patent Laid-Open No. 2024-064361 discloses suppressing visually induced motion sickness experienced by a viewer, by generating the composite video such that a panning video displayed in a panning area is captured as a video with fewer captured frames per predetermined amount of time than a focus video displayed in a focus area.

However, in the configuration of Japanese Patent Laid-Open No. 2024-064361, since a change amount of the focus video displayed in the focus area may also increase when the vehicle turns, there is a possibility that the viewer of an image experiences visually induced motion sickness even if the number of displayed captured frames is changed between the focus area and the panning area.

The present invention was made in view of the above-described circumstances and has an object to enable suppression of visually induced motion sickness experienced by a viewer of an image. Therefore, through a service for connecting remote locations and vehicles, the present invention contributes to supporting good connection between urban areas and regional areas such as those surrounding urban areas, and to the development of sustainable transportation systems.

### SUMMARY OF THE INVENTION

An aspect of the present invention is a streaming system including: a streaming unit configured to stream an image obtained through capturing by a capturing apparatus provided in a vehicle; a display apparatus provided in a location other than the vehicle and configured to display the image streamed by the streaming unit; and a first estimation unit configured to estimate a first amount of time from when the vehicle starts turning until the vehicle finishes turning, based on information of a surrounding area of the vehicle, wherein the display apparatus displays the first amount of time estimated by the first estimation unit along with the image streamed by the streaming unit.

According to the above aspect of the present invention, it is possible to suppress visually induced motion sickness experienced by a viewer of the image.

### BRIEF DESCRIPTION OF THE DRAWINGS

FIG. 1 is a diagram showing a system configuration of a streaming system;

FIG. 2 is a diagram showing an attachment example of a streamer terminal in a vehicle;

FIG. 3 is a diagram showing the attachment example of the streamer terminal in the vehicle;

FIG. 4 is a diagram showing a configuration of the vehicle and a streaming server;

FIG. 5 is a diagram showing functional units of a first processor;

FIG. 6 is a diagram showing an example of a first composite image;

FIG. 7 is a diagram showing an example of a second composite image;

FIG. 8 is a diagram showing a configuration of a user information DB;

FIG. 9 is a diagram showing a configuration of a stream management DB;

FIG. 10 is a block diagram showing a configuration of a viewer terminal;

FIG. 11 shows flowcharts showing an operation of an in-vehicle apparatus, the streaming server, and the viewer terminal;

FIG. 12 is a flowchart showing an operation of the in-vehicle apparatus;

FIG. 13 is a flowchart showing an operation of the viewer terminal; and

FIG. 14 is a diagram for describing processing by an image processing unit.

### DETAILED DESCRIPTION OF THE INVENTION

### 1. First Embodiment

### 1-1. Configuration of Streaming System

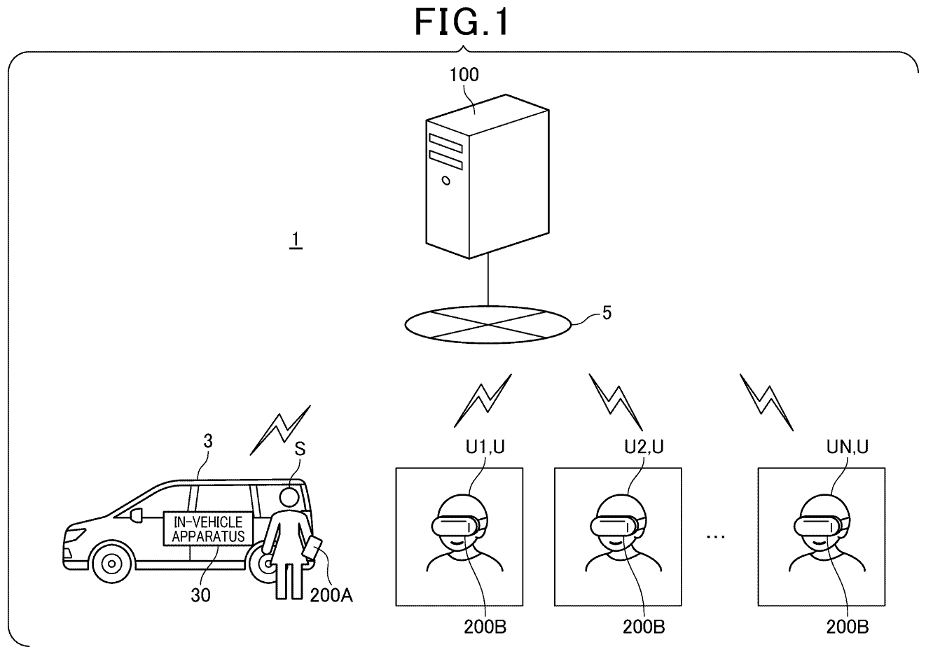

FIG. 1 is a diagram showing a system configuration of a streaming system 1.

The streaming system 1 includes a vehicle 3, a streamer terminal 200A, a streaming server 100, and a viewer terminal 200B. The streaming system 1 is a system for live streaming content including an image obtained through capturing by the streamer terminal 200A.

Live streaming refers to streaming the image obtained through capturing by the streamer terminal 200A to the viewer terminal 200B in real-time. The image may be a still image or a moving image.

The streamer terminal 200A is an example of a “capturing apparatus.” The viewer terminal 200B is an example of a “display apparatus.”

An in-vehicle apparatus 30 is installed in the vehicle 3. The in-vehicle apparatus 30 is wirelessly connected via short-range wireless communication or the like to the streamer terminal 200A possessed by a streamer S being an occupant of the vehicle 3. The in-vehicle apparatus 30 receives, from the streamer terminal 200A, the image obtained through capturing by a camera included in the streamer terminal 200A. The in-vehicle apparatus 30 uploads content data including the received image to the streaming server 100. Note that the content data may include sound collected inside of the vehicle 3, or may include sound from outside of the vehicle 3.

The streamer terminal 200A may be a smartphone or tablet personal computer (PC), or may be a camera such as a digital camera or a 360-degree camera capable of capturing an entire surrounding area.

The streamer terminal 200A is provided inside of the vehicle 3.

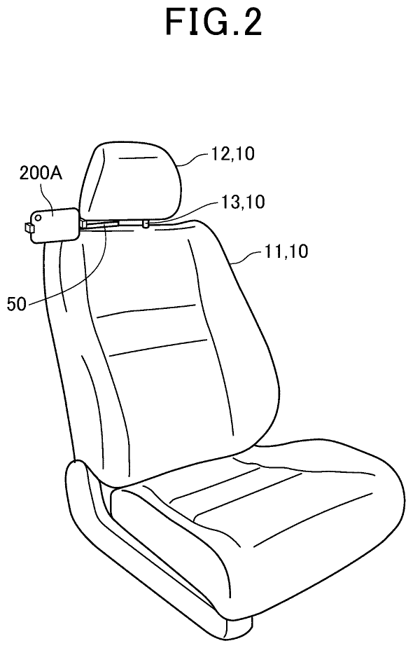

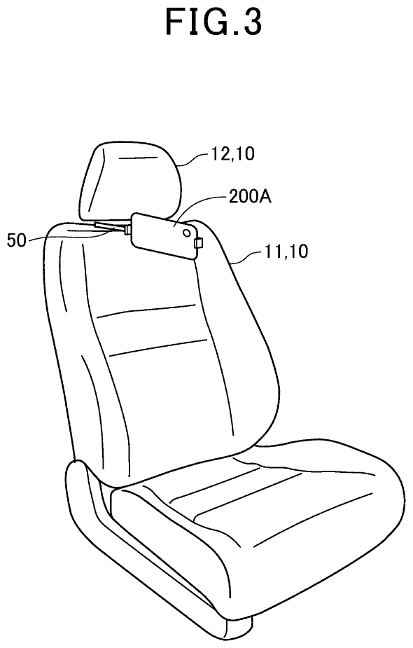

FIGS. 2 and 3 are diagrams showing attachment examples of the streamer terminal 200A in the vehicle 3.

FIGS. 2 and 3 show examples in which the streamer terminal 200A is attached to a passenger seat 10 of the vehicle 3.

The streamer terminal 200A is attached to the seat 10 via an attachment 50. The attachment 50 is attached to a headrest stay 13 that fixes a headrest 12 of the passenger seat 10 to a backrest 11.

FIG. 2 shows an example in which the streamer terminal 200A is attached to the passenger seat 10 so that an area in front of the vehicle 3 is included in an angle of view of the streamer terminal 200A. This attachment position of the streamer terminal 200A is referred to as a first position. FIG. 3 shows an example in which the streamer terminal 200A is attached to the passenger seat 10 so that the streamer S seated in a driver seat is included in the angle of view of the streamer terminal 200A. This attachment position of the streamer terminal 200A is referred to as a second position.

A first holder 51 for fixing the streamer terminal 200A to the attachment 50 is provided at one end portion of the attachment 50 and a second holder for fixing the attachment 50 to the headrest stay 13 is provided at the other end portion of the attachment 50. Illustration of the second holder is omitted. After changing an attachment direction of the attachment 50 to the headrest stay 13, the streamer terminal 200A is attached to the passenger seat 10 in the first position or the second position by fixing the attachment 50 to the headrest stay 13 via the second holder.

Returning to the description of FIG. 1, the streaming server 100 streams content streamed from the vehicle 3 to the viewer terminal 200B of a viewer U. This streaming technology can be realized using known technology such as HTTP Live Streaming (HLS), Common Media Application Format (CMAF), Web Real-Time Communication (WebRTC), or Real-Time Messaging Protocol (RTMP).

The viewer terminal 200B is a display apparatus possessed by the viewer U that views the content streamed from the streaming server 100. FIG. 1 shows U1, U2, ..., UN viewers U as the viewer U. N is an arbitrary natural number.

For example, the viewer terminal 200B may be a portable or mobile terminal apparatus such as a smartphone, a tablet PC, or a notebook PC, or may be a stationary terminal apparatus such as a desktop PC. The viewer terminal 200B may be a television set, or a head-mounted display apparatus in which an image display part is mounted on the head of the viewer U and a display included in the image display part is arranged in front of the eyes of the viewer U. The head-mounted display apparatus may be transmissive or non-transmissive, as long as the content streamed from the streaming server 100 can be viewed. In the present embodiment, the viewer terminal 200B is exemplified as a non-transmissive head-mounted display apparatus.

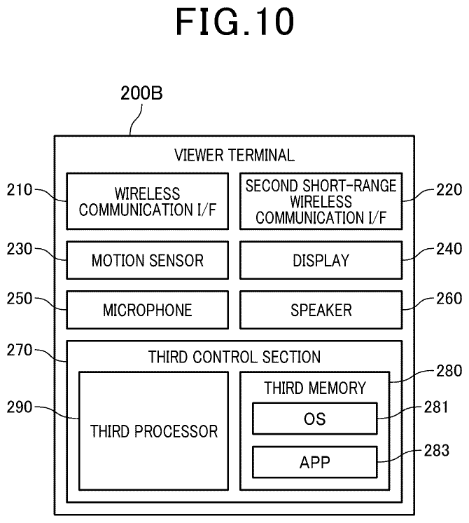

The viewer terminal 200B includes a display 240 (see FIG. 10), displays an image streamed from the streaming server 100 on the display 240, and outputs speech streamed from the streaming server 100 via a speaker 260.

A communication network 5 is a wired or wireless transmission path for information transmitted from an apparatus connected to the communication network 5. For example, the communication network 5 may include a public network such as the Internet, a mobile communication network, a satellite communication network, or various local area networks (LANs) including Ethernet (registered trademark) or a wide area network (WAN). The communication network 5 may include a dedicated network such as an Internet protocol-virtual private network (IP-VPN).

### 1-2. Configuration of Vehicle

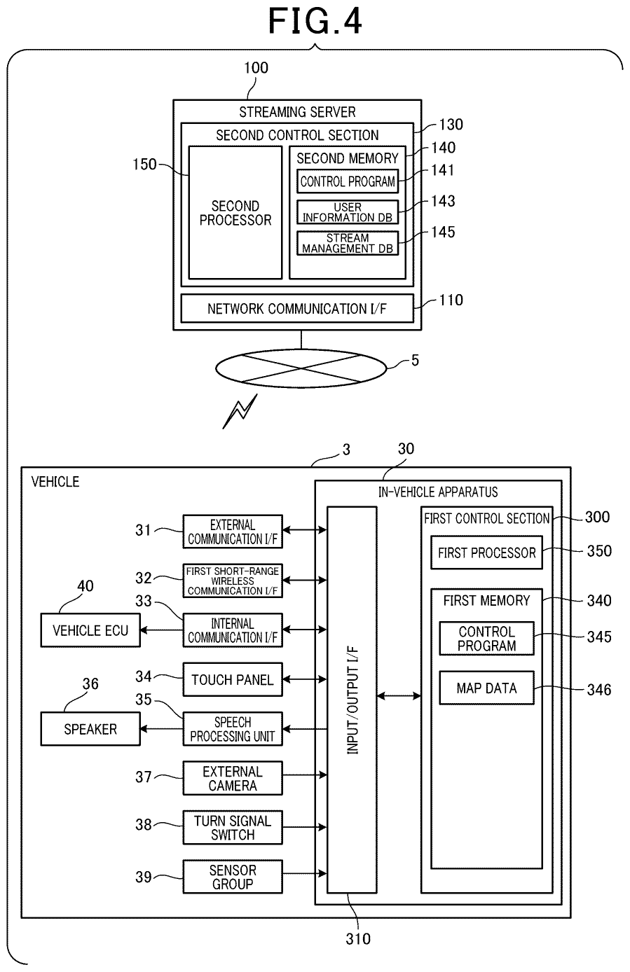

FIG. 4 is a diagram showing a configuration of the vehicle 3 and the streaming server 100.

First, the configuration of the vehicle 3 will be described with reference to FIG. 4.

The vehicle 3 includes the in-vehicle apparatus 30, an external communication interface 31, a first short-range wireless communication interface 32, an internal communication interface 33, a touch panel 34, a speech processing unit 35, the speaker 36, the external camera 37, the turn signal switch 38, and a sensor group 39. Hereinafter, interface will be abbreviated as I/F.

First, the external communication interface 31, the first short-range wireless communication interface 32, the internal communication interface 33, the touch panel 34, the speech processing unit 35, the speaker 36, the external camera 37, the turn signal switch 38, and the sensor group 39 will be described.

The external communication I/F 31 is a communication module that performs wireless communication in accordance with a mobile communication standard such as long-term evolution (LTE), fourth-generation (4G), 5G, or Wi-Fi (registered trademark). The external communication I/F 31 is connected to the communication network 5 via an antenna (not shown) and performs mutual data transmission/reception with the streaming server 100. Note that the external communication I/F 31 is, for example, a telematics control unit (TCU).

For example, the first short-range wireless communication I/F 32 (transmitter/receiver, circuit) is a communication apparatus that performs wireless communication in accordance with a short-range wireless communication standard such as Bluetooth (registered trademark) or Wi-Fi. For example, the first short-range wireless communication I/F 32 is a communication module that performs communication in accordance with a near-field communication (NFC) standard such as Bluetooth or Wi-Fi. The first short-range wireless communication I/F 32 performs short-range wireless communication with a terminal apparatus possessed by an occupant and receives an image, speech, and the like captured by the terminal apparatus.

The internal communication I/F 33 (transmitter/receiver, circuit) is an input/output interface connected to an in-vehicle network (not shown). For example, a communication bus supporting a communication standard such as controller area network (CAN), CAN with Flexible Data-Rate (CAN FD), or Ethernet is used for the in-vehicle network. The internal communication I/F 33 performs mutual data communication via the in-vehicle network with in-vehicle equipment such as a vehicle ECU 40 (computer) or another relay apparatus.

The touch panel 34 includes a display panel such as a liquid-crystal panel or an organic electroluminescent (EL) panel, and a touch sensor. The touch sensor detects a touch operation by the viewer U on the touch panel 34 and outputs position information indicating a position of the detected touch operation to a first control section 330.

For example, the speech processing unit 35 (processor) converts digital speech data output by the first control section 330 into an analog speech signal. The speech processing unit 35 amplifies the converted analog speech signal and outputs the amplified speech signal via the speaker 36.

The external camera 37 is installed at a front of the vehicle 3 and captures an area in front of the vehicle 3. The external camera 37 includes a road surface of a road on which the vehicle 3 is traveling within a captured range. The external camera 37 captures at predetermined intervals and outputs data of the image obtained through capturing to the in-vehicle apparatus 30.

The turn signal switch 38 is a switch for instructing a direction indicator provided in the vehicle 3 to blink or be turned off. When a driver performs an operation to cause the direction indicator to blink, the turn signal switch 38 instructs the direction indicator to blink and outputs data indicating that the direction indicator has been caused to blink to the in-vehicle apparatus 30. When the driver performs an operation to cause the direction indicator to be turned off, the turn signal switch 38 instructs the direction indicator to be turned off and outputs data indicating that the direction indicator has been turned off to the in-vehicle apparatus 30.

The sensor group 39 includes various sensors. The sensor group 39 of the present embodiment includes an acceleration sensor, a vehicle speed sensor, a global navigation satellite system (GNSS) unit, and a steering angle sensor.

The acceleration sensor is a sensor that detects an acceleration of the vehicle 3. The acceleration sensor detects the acceleration of the vehicle 3 at predetermined intervals and outputs a detected value to the in-vehicle apparatus 30 every time the acceleration sensor detects the acceleration of the vehicle 3.

The vehicle speed sensor is a sensor that detects a speed of the vehicle 3. The vehicle speed sensor detects the speed of the vehicle 3 at predetermined intervals and outputs a detected value to the in-vehicle apparatus 30 every time the vehicle speed sensor detects the speed of the vehicle 3.

The GNSS unit measures a current position of the vehicle 3. The GNSS unit generates position data indicating the current position of the vehicle 3 and outputs the generated position data to the in-vehicle apparatus 30.

A yaw rate sensor is a sensor that detects a yaw angle of the vehicle 3. The yaw rate sensor detects the yaw angle at predetermined intervals and outputs a detected value to the in-vehicle apparatus 30.

The in-vehicle apparatus 30 includes an input/output I/F 310 and the first control section 330.

The input/output I/F 310 functions as a connection unit between the first control section 330 and the external communication I/F 31, the first short-range wireless communication I/F 32, the internal communication I/F 33, the touch panel 34, the speech processing unit 35, the external camera 37, the turn signal switch 38, and the sensor group 39. The input/output I/F 310 includes a connector and an interface circuit. The input/output I/F 310 outputs data input from the external communication I/F 31, the first short-range wireless communication I/F 32, the internal communication I/F 33, the touch panel 34, the speech processing unit 35, the external camera 37, the turn signal switch, and the sensor group 39 to the first control section 330. The input/output I/F 310 outputs data input from the first control section 330 to the external communication I/F 31, the first short-range wireless communication I/F 32, the internal communication I/F 33, the touch panel 34, and the speech processing unit 35.

The first control section 330 is a computer apparatus including a first memory 340 and a first processor 350.

The first memory 340 includes, for example, a volatile semiconductor memory and a non-volatile semiconductor memory. The first memory 340 may include only a non-volatile semiconductor memory. The first memory 340 may include an auxiliary storage apparatus such as a solid-state drive (SSD). The first memory 340 stores a control program 345 executed by the first processor 350, map data 346, configuration data that defines an operation of the in-vehicle apparatus 30, and the like.

The map data 346 is data including road map information, building information, and the like. The road map information includes information relating to a road network in which roads on a map are represented by lines, intersections and junctions are divided into a plurality of portions as nodes, and portions between each node are specified as links. The building information indicates a position of a building, a name of the building, a shape of the building when viewed from above, and the like.

The first processor 350 is, for example, an arithmetic processing apparatus such as a central processing unit (CPU) or a microprocessing unit (MPU). The first processor 350 may be implemented as a single processor or as a plurality of processors. The first processor 350 may be implemented as a system on a chip (SoC) integrated with part or all of the first memory 340, or with another circuit.

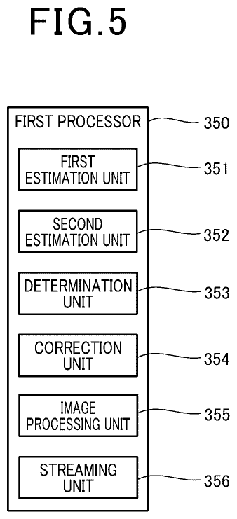

FIG. 5 is a diagram showing functional units of the first processor 350.

The first processor 350 functions as a first estimation unit 351, a second estimation unit 352, a determination unit 353, a correction unit 354, an image processing unit 355, and a streaming unit 356 by loading and executing the control program 345 stored in the first memory 340.

### 1-2-1. First Estimation Unit

The first estimation unit 351 estimates, based on information of a surrounding area of the vehicle 3, an amount of time from when the vehicle 3 starts turning until the vehicle 3 finishes turning (hereinafter referred to as a “first amount of time”).

The first estimation unit 351 estimates the first amount of time, when the in-vehicle apparatus 30 receives the data indicating that the direction indicator has been caused to blink from the turn signal switch 38, in other words, when the direction indicator has been operated. An example is given of when the vehicle 3 turns at an intersection as a circumstance in which the first amount of time is estimated in this case. The first estimation unit 351 estimates the first amount of time by further adding time to a predetermined reference amount of time (for example, 5 seconds or 6 seconds) in accordance with the number of other vehicles, pedestrians, or the like in the surrounding area of the vehicle 3.

The first estimation unit 351 acquires the number of other vehicles present in the surrounding area of the vehicle 3 as the information of the surrounding area of the vehicle 3, by performing pattern matching or the like on the image obtained through capturing by the external camera 37, by performing inter-vehicle communication, or the like. The first estimation unit 351 acquires the number of pedestrians present in the surrounding area of the vehicle 3 as the information of the surrounding area of the vehicle 3, by performing pattern matching or the like on the image obtained through capturing by the external camera 37. Note that the first estimation unit 351 may acquire the number of pedestrians through vehicle-to-road communication.

Upon acquiring the number of other vehicles and the number of pedestrians, the first estimation unit 351 calculates an additional time to be added to the reference amount of time by using a predetermined algorithm. The first estimation unit 351 estimates the first amount of time by adding the additional time to the reference amount of time. Note that this predetermined algorithm is an algorithm for which the additional time increases the greater the number of vehicles is and the greater the number of pedestrians is.

The first estimation unit 351 estimates the first amount of time when the vehicle 3 is positioned a predetermined distance before a curve that the vehicle 3 plans to enter. The first estimation unit 351 acquires map information of the surrounding area of the vehicle 3, based on the map data 346 and the current position of the vehicle 3 measured by the GNSS unit. The first estimation unit 351 determines, with reference to the acquired map information, whether the vehicle 3 is positioned at the predetermined distance before the curve that the vehicle 3 plans to enter. This determination is performed based on a link forming the curve (among links forming the curve, the link that the vehicle 3 first plans to enter) and the current position of the vehicle 3. The first estimation unit 351 estimates the first amount of time when determining that the vehicle 3 is positioned the predetermined distance before the curve that the vehicle 3 plans to enter. The first estimation unit 351 calculates a length of the curve that the vehicle 3 plans to enter, based on the number of links forming the curve and a length of each link. Subsequently, the first estimation unit 351 calculates a speed obtained by subtracting a predetermined speed from a vehicle speed detected by the vehicle speed sensor as the speed of the vehicle 3 when navigating the curve. The first estimation unit 351 estimates the first amount of time by multiplying the calculated length of the curve by the speed of the vehicle 3 when navigating the curve.

Upon estimating the first amount of time, the first estimation unit 351 outputs the estimated first amount of time to the image processing unit 355.

### 1-2-2. Second Estimation Unit

The second estimation unit 352 estimates an amount of time until the vehicle 3 starts turning (hereinafter referred to as a “second amount of time”).

The second estimation unit 352 estimates the second amount of time, when the in-vehicle apparatus 30 receives the data indicating that the direction indicator has been caused to blink from the turn signal switch 38, in other words, when the direction indicator has been operated. A case is assumed in which the vehicle 3 is about to turn at an intersection as a circumstance in which the second amount of time is estimated in this case. The second estimation unit 352 acquires the map information of the surrounding area of the vehicle 3, based on the map data 346 and the current position of the vehicle 3 measured by the GNSS unit. The second estimation unit 352 calculates, with reference to the acquired map information, a distance between the current position of the vehicle 3 and the intersection. This calculation is performed based on nodes corresponding to the intersection and the current position of the vehicle 3. Subsequently, the second estimation unit 352 estimates the second amount of time by dividing the calculated distance between the vehicle 3 and the intersection by the vehicle speed detected by the vehicle speed sensor of the sensor group 39.

Note that an estimation method of the second amount of time performed by the second estimation unit 352 is not limited to this method. The second estimation unit 352 may calculate the distance between the vehicle 3 and the intersection based on a size of a target object depicted in the image obtained through capturing by the external camera 37, and estimate the second amount of time using the calculated distance and the speed of the vehicle 3. For example, the second estimation unit 352 calculates the distance between the vehicle 3 and the intersection by comparing a size of a traffic light depicted in the image obtained through capturing by the external camera 37 with a threshold value.

The second estimation unit 352 estimates the second amount of time when the vehicle 3 is positioned a predetermined distance before a curve that the vehicle 3 plans to enter. Similar to the first estimation unit 351, the second estimation unit 352 determines whether the vehicle 3 is positioned at the predetermined distance before the curve that the vehicle 3 plans to enter. The second estimation unit 352 estimates the second amount of time when determining that the vehicle 3 is positioned the predetermined distance before the curve that the vehicle 3 plans to enter. The second estimation unit 352 calculates a distance between the curve that the vehicle 3 plans to enter and the vehicle 3, based on a link forming the curve that the vehicle 3 plans to enter (among links forming the curve, the link that the vehicle 3 first plans to enter) and the current position of the vehicle 3. Subsequently, the second estimation unit 352 estimates the second amount of time by dividing the calculated distance by the vehicle speed detected by the vehicle speed sensor of the sensor group 39.

Upon estimating the second amount of time, the second estimation unit 352 outputs the estimated second amount of time to the image processing unit 355.

### 1-2-3. Determination Unit

The determination unit 353 determines whether an irregularity is present in the road surface of the road on which the vehicle 3 is traveling.

The determination unit 353 detects an irregularity through image processing such as pattern matching from the road surface depicted in the image obtained through capturing by the external camera 37, and determines whether a predetermined number of irregularities or more of a predetermined depth or height or greater are present. The determination unit 353 determines that an irregularity is present in the road surface of the road on which the vehicle 3 is traveling when determining that the predetermined number of irregularities or more of the predetermined depth or height or greater are present, and determines an irregularity is not present in the road surface of the road on which the vehicle 3 is traveling when determining that the predetermined number of irregularities or more of the predetermined depth or height or greater are not present. An irregularity in the road surface includes gravel or the like laid on the road, a pothole, debris, ruts, or the like.

The determination unit 353 outputs a determination result to the correction unit 354.

### 1-2-4. Correction Unit

The correction unit 354 acquires the image obtained through capturing by the streamer terminal 200A from the streamer terminal 200A via the first short-range wireless communication I/F 32. The correction unit 354 corrects blurring in the image acquired from the streamer terminal 200A, when the determination result acquired from the determination unit 353 indicates that an irregularity is present in the road surface. On the other hand, the correction unit 354 outputs the image acquired from the streamer terminal 200A to the image processing unit 355 without correcting blurring in the image acquired from the streamer terminal 200A, when the determination result acquired from the determination unit 353 indicates that an irregularity is not present in the road surface.

The correction unit 354 corrects blurring in the image acquired from the streamer terminal 200A using an existing electronic hand stabilization method. This electronic hand stabilization method is a method of correcting image displacement through pixel shifting, by comparing a certain image with an image obtained after the certain image. Upon correcting the blurring in the image acquired by the streamer terminal 200A, the correction unit 354 outputs the corrected image to the image processing unit 355.

### 1-2-5. Image Processing Unit

The image processing unit 355 adds various information to the image acquired from the correction unit 354. The image processing unit 355 adds various information to the image in which the blurring has been corrected when the correction unit 354 corrects blurring in the image, and adds various information to the image that has not been corrected by the correction unit 354 when the correction unit 354 does not correct blurring in the image.

### 1-2-5-1. Addition of First Amount of Time

When acquiring the first amount of time from the first estimation unit 351, the image processing unit 355 adds first-amount-of-time information J1 and turning-in-progress information J2 to the image acquired from the correction unit 354 and generates a first composite image CP1. The first-amount-of-time information J1 is information including the first amount of time. The turning-in-progress information J2 is information indicating that the vehicle 3 is currently turning.

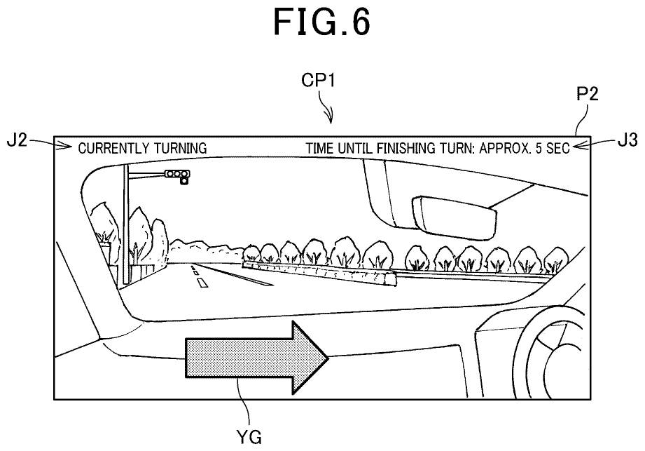

FIG. 6 is a diagram showing an example of the first composite image CP1.

FIG. 6 exemplifies a case in which the first-amount-of-time information J1 has been added to an image P1. The image P1 shown in FIG. 6 is an image captured from the passenger seat of the vehicle 3 and depicts the area in front of the vehicle 3 through a windshield.

In FIG. 6, the first-amount-of-time information J1 is the text “time until finishing turn: approx. 5 sec.” The first amount of time indicated by the first-amount-of-time information J1 of FIG. 6 is “5 seconds.” Note that a position at which the first-amount-of-time information J1 is added is not limited to the position in FIG. 6. However, from the perspective of visibility, the first-amount-of-time information J1 is preferably in a region other than the windshield among regions depicted in the image to be added.

In FIG. 6, the turning-in-progress information J2 is the text “currently turning.” Note that a position at which the turning-in-progress information J2 is added is not limited to the position in FIG. 6. However, from the perspective of visibility, the turning-in-progress information J2 is preferably in a region other than the windshield among the regions depicted in the image to be added.

When the direction indicator is operated, the image processing unit 355 generates the first composite image CP1 to which information has further been added indicating that the direction indicator has been operated. FIG. 6 exemplifies a case in which an arrow image YG has been added to the image P1 indicating that the direction indicator has been operated. A direction indicated by the arrow image YG corresponds to the operated direction indicator.

When acquiring the first amount of time from the first estimation unit 351, the image processing unit 355 adds the first-amount-of-time information J1 and the turning-in-progress information J2 to the image acquired from the correction unit 354 until the vehicle 3 finishes turning. When the direction indicator is operated, the image processing unit 355 adds the arrow image YG to the image acquired from the correction unit 354 until the in-vehicle apparatus 30 receives data indicating that the direction indicator has been turned off.

Upon generating the first composite image CP1, the image processing unit 355 outputs the first composite image CP1 to the streaming unit 356.

### 1-2-5-2. Addition of Second Amount of Time

When acquiring the second amount of time from the second estimation unit 352, the image processing unit 355 adds second-amount-of-time information J3 to the image acquired from the correction unit 354 and generates a second composite image CP2. The second-amount-of-time information J3 is information including the second amount of time.

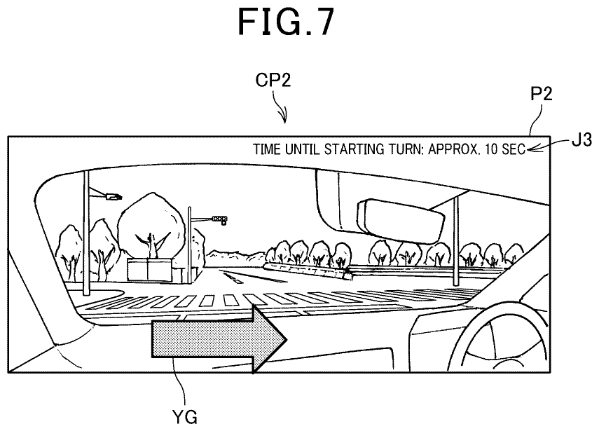

FIG. 7 is a diagram showing an example of the second composite image CP2.

FIG. 7 exemplifies a case in which the second-amount-of-time information J3 has been added to an image P2. The image P2 shown in FIG. 7 is an image captured from the passenger seat of the vehicle 3 and depicts the area in front of the vehicle 3 through the windshield.

In FIG. 7, the second-amount-of-time information J3 is the text “time until starting turn: approx. 10 sec.” The second amount of time indicated by the second-amount-of-time information J3 of FIG. 7 is “10 seconds.” Note that a position at which the second-amount-of-time information J3 is added is not limited to the position in FIG. 7. However, from the perspective of visibility, the second-amount-of-time information J3 is preferably in a region other than the windshield among regions depicted in the image to be added.

When the direction indicator is operated, the image processing unit 355 generates the second composite image CP2 to which information has further been added indicating that the direction indicator has been operated. FIG. 7 exemplifies a case in which the arrow image YG has been added to the image P2 indicating that the direction indicator has been operated. A direction indicated by the arrow image YG corresponds to the operated direction indicator.

When acquiring the second amount of time from the second estimation unit 352, the image processing unit 355 adds the second-amount-of-time information J3 to the image acquired from the correction unit 354 until the vehicle 3 finishes turning. When the direction indicator is operated, the image processing unit 355 adds the arrow image YG to the image acquired from the correction unit 354 until the in-vehicle apparatus 30 receives data indicating that the direction indicator has been turned off.

Upon generating the second composite image CP2, the image processing unit 355 outputs the second composite image CP2 to the streaming unit 356.

When not adding the first-amount-of-time information J1, the second-amount-of-time information J3, and the arrow image YG, the image processing unit 355 outputs the image acquired from the correction unit 354 to the streaming unit 356 without performing processing on the image acquired from the correction unit 354.

### 1-2-6. Streaming Unit

The streaming unit 356 streams the image acquired from the image processing unit 355 to the viewer terminal 200B via the external communication I/F 31. More specifically, the streaming unit 356 uploads, to the streaming server 100 via the external communication I/F 31, content data including the image acquired from the image processing unit 355 along with a stream identification (ID).

### 1-3. Configuration of Streaming Server

Next, the configuration of the streaming server 100 will be described with reference to FIG. 4.

The streaming server 100 includes a network communication I/F 110 and a second control section 130.

For example, the network communication I/F 110 includes a communication card such as a network interface card (NIC), and performs mutual data communication via the communication network 5 with the vehicle 3, the viewer terminal 200B, and the like.

The second control section 130 is a computer apparatus including a second memory 140 and a second processor 150.

The second memory 140 includes, for example, a volatile semiconductor memory and a non-volatile semiconductor memory. The second memory 140 may include only a non-volatile semiconductor memory. The second memory 140 may include an auxiliary storage apparatus such as a hard disk drive (HDD) or an SSD.

The second memory 140 stores a control program 141 executed by the second processor 150, a user information database 143, and a stream management database 145. Hereinafter, database will be abbreviated as DB.

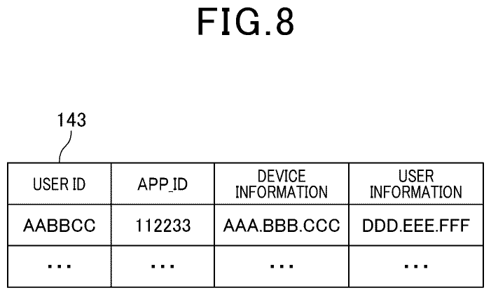

FIG. 8 is a diagram showing a configuration of the user information DB 143.

One record in the user information DB 143 includes a user ID, APP_ID, device information, and user information. APP is an abbreviation of application program.

The user ID is identification information for identifying a user utilizing a streaming service provided by the streaming server 100. The user includes the streamer S and the viewer U.

APP_ID is identification information for identifying an application program downloaded on the streamer terminal 200A or the viewer terminal 200B.

The streamer S and the viewer U download the APP from a predetermined website and respectively install the APP on the streamer terminal 200A and the viewer terminal 200B.

The device information is information related to the viewer terminal 200B. The device information is, for example, information indicating whether the viewer terminal 200B is a smartphone, a PC, a head-mounted display apparatus, or a camera. For example, a model number is used for the device information. The device information includes communication information for communicating with the viewer terminal 200B. Note that an example of this communication information includes address information.

The user information is personal information of the streamer S and the viewer U being the user. The user information includes, for example, information such as name, address, sex, and age.

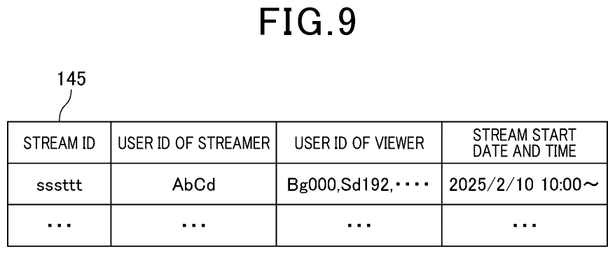

FIG. 9 is a diagram showing a configuration of the stream management DB 145.

One record in the stream management DB 145 includes a stream ID for identifying a stream, the user ID of the streamer S, the user ID of the viewer U, and a stream start date and time.

Returning to FIG. 4, the configuration of the streaming server 100 will be described further.

The second processor 150 is, for example, an arithmetic processing apparatus such as a CPU or an MPU. The second processor 150 may be implemented as a single processor or as a plurality of processors. The second processor 150 may be implemented as an SoC integrated with part or all of the second memory 140, or with another circuit.

The second control section 130 executes various operations by the second processor 150 loading and executing the control program 141.

### 1-4. Configuration of Viewer Terminal

FIG. 10 is a block diagram showing a configuration of the viewer terminal 200B.

The viewer terminal 200B includes a wireless communication I/F 210, a second short-range wireless communication I/F 220, the motion sensor 230, the display 240, the microphone 250, the speaker 260, and a third control section 270.

The wireless communication I/F 210 is a communication module that performs wireless communication in accordance with a mobile communication standard such as LTE, 4G, 5G, or Wi-Fi. The wireless communication I/F 210 is connected to the communication network 5 via an antenna (not shown) and performs mutual data transmission/reception with the streaming server 100.

For example, the second short-range wireless communication I/F 220 (transmitter/receiver, circuit) is a communication module that performs communication in accordance with an NFC standard such as Bluetooth or Wi-Fi. The second short-range wireless communication I/F 220 can transmit speech input via the microphone 250 to the in-vehicle apparatus 30 via the streaming server 100 through short-range wireless communication with the in-vehicle apparatus 30.

The motion sensor 230 is a 9-axis sensor that detects acceleration (3 axes), angular velocity (3 axes), and geomagnetism (3 axes). When mounted on the head of the viewer U, the motion sensor 230 detects movement of the head of the viewer U. The motion sensor 230 performs detection at predetermined intervals and outputs a detected value to the third control section 270.

The microphone 250 is a speech input apparatus for inputting speech of the streamer S, the viewer U, and the like. The speaker 260 is a speech output apparatus for outputting speech of the streamer S, the viewer U, and the like.

The display 240 includes a display panel such as a liquid-crystal panel or an organic EL panel, and a touch sensor. The display 240 functions as a display part for displaying an image and as a reception part for accepting an operation by the streamer S, the viewer U, and the like.

The third control section 270 is a computer apparatus including a third memory 280 and a third processor 290.

The third processor 290 is an example of a “processor.”

The third memory 280 includes a non-volatile semiconductor memory. The third memory 280 may include an auxiliary storage apparatus such as an SD card. The third memory 280 stores control programs such as an operating system (OS) 281 and an APP 283. The APP 283 is an application program that performs mutual data communication with the streaming server 100, displays an image included in content streamed by the streaming server 100 on the display 240, and outputs speech included in the content to the speaker 260.

The APP 283 is an example of a “program.”

The third processor 290 is, for example, an arithmetic processing apparatus such as a CPU or an MPU. The third processor 290 may be implemented as a single processor or as a plurality of processors.

The third control section 270 communicates with the streaming server 100 via the wireless communication I/F 210 by the third processor 290 loading and executing the APP 283.

The third control section 270 displays the image included in the content streamed by the streaming server 100 on the display 240 by the third processor 290 loading and executing the APP 283.

The third control section 270 outputs the speech included in the content streamed by the streaming server 100 from the speaker 260 by the third processor 290 loading and executing the APP 283.

The third control section 270 detects an orientation of the viewer terminal 200B in a state of being mounted on the viewer U based on the detected value from the motion sensor 230, by the third processor 290 loading and executing the APP 283. The orientation of the viewer terminal 200B corresponds to a direction in which the face of the viewer U is facing and indicates an orientation in a left-right direction, with the viewer U on which the viewer terminal 200B is mounted as reference.

### 1-5. Operation

Next, an operation of each unit of the streaming system 1 according to the present embodiment will be described.

First, the operation of each unit of the streaming system 1 during streaming of the content will be described.

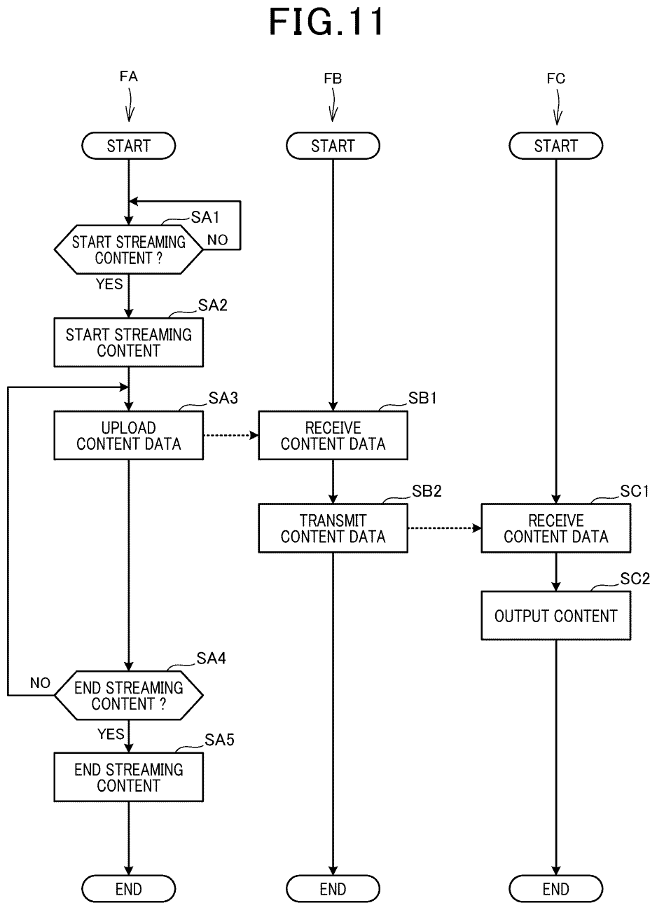

FIG. 11 shows flowcharts showing an operation of the in-vehicle apparatus 30, the streaming server 100, and the viewer terminal 200B. In FIG. 11, a flowchart FA indicates the operation of the in-vehicle apparatus 30, a flowchart FB indicates the operation of the streaming server 100, and a flowchart FC indicates the operation of the viewer terminal 200B.

As shown in the flowchart FA, the streaming unit 356 determines whether to start streaming the content (step SA1).

For example, when the touch panel 34 receives a streaming start instruction, the streaming unit 356 makes a positive determination in step SA1.

For example, when the in-vehicle apparatus 30 receives streaming start information from the streamer terminal 200A, the streaming unit 356 makes the positive determination in step SA1. Note that the streaming start information is information indicating the start of streaming.

When determining to start streaming the content (YES in step SA1), the streaming unit 356 starts streaming the content (step SA2). Upon starting streaming of the content, the streaming unit 356 uploads the content data at predetermined intervals to the streaming server 100 (step SA3).

Step SA3 is an example of a “streaming step.”

As shown in the flowchart FB, the second control section 130 of the streaming server 100 receives the content data from the in-vehicle apparatus 30 (step SB1).

Subsequently, the second control section 130 of the streaming server 100 transmits the received content data to the viewer terminal 200B (step SB2).

Step SB2 will be described in detail below. The second control section 130 identifies a record including the stream ID received together with the content data from the stream management DB 145 and acquires the user ID of the viewer U from the identified record. Subsequently, the second control section 130 acquires the device information per acquired user ID of the viewer U. The second control section 130 then transmits the received content data, based on the communication information included in the acquired device information.

As shown in the flowchart FC, the third control section 270 of the viewer terminal 200B receives the content data from the streaming server 100 (step SC1).

Subsequently, the third control section 270 displays the image included in the content indicated by the received content data on the display 240 and outputs the speech included in the content indicated by the received content data via the speaker 260 (step SC2).

Step SC2 is an example of a “display step.”

Returning to the description of the flowchart FA, the streaming unit 356 determines whether to end streaming the content (step SA4).

For example, when the touch panel 34 receives a streaming end instruction, the streaming unit 356 makes a positive determination in step SA4.

For example, when the in-vehicle apparatus 30 receives streaming end information from the streamer terminal 200A, the streaming unit 356 makes the positive determination in step SA4. Note that the streaming end information is information indicating the end of streaming.

When determining not to end streaming the content (NO in step SA4), the streaming unit 356 returns the processing to step SA3 and performs the processing from step SA3 onward once more. Note that the streaming unit 356 continues streaming the content until a positive determination is made in step SA4.

On the other hand, when determining to end streaming the content (YES in step SA4), the streaming unit 356 ends streaming the content (step SA5).

As described above, various information is added by the image processing unit 355 to the image to be streamed to the viewer terminal 200B, that is, the image obtained through capturing by the streamer terminal 200A.

Next, the operation of the in-vehicle apparatus 30 will be described.

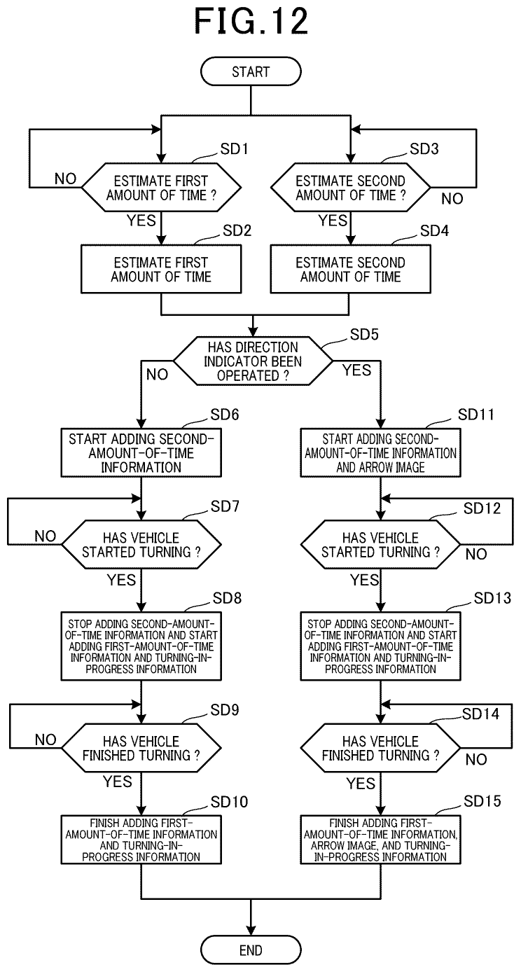

FIG. 12 is a flowchart showing the operation of the in-vehicle apparatus 30.

The first estimation unit 351 determines whether to estimate the first amount of time (step SD1).

Step SD1 will be described in detail below.

When the in-vehicle apparatus 30 receives data indicating that the direction indicator has been caused to blink, the first estimation unit 351 makes a positive determination in step SD1.

When the vehicle 3 is positioned a predetermined distance before a curve that the vehicle 3 plans to enter, the first estimation unit 351 makes the positive determination in step SD1.

When determining not to estimate the first amount of time (NO in step SD1), the first estimation unit 351 performs the determining of step SD1 once more.

On the other hand, when determining to estimate the first amount of time (YES in step SD1), the first estimation unit 351 estimates the first amount of time (step SD2).

Step SD2 is an example of an “estimation step.”

The second estimation unit 352 determines whether to estimate the second amount of time (step SD3). The determining of step SD3 is performed in parallel with the determining of step SD1.

Step SD3 will be described in detail below.

When the in-vehicle apparatus 30 receives data indicating that the direction indicator has been caused to blink, the second estimation unit 352 makes a positive determination in step SD3.

When the vehicle 3 is positioned the predetermined distance before the curve that the vehicle 3 plans to enter, the second estimation unit 352 makes the positive determination in step SD3.

When determining not to estimate the second amount of time (NO in step SD3), the second estimation unit 352 performs the determining of step SD3 once more.

On the other hand, when determining to estimate the second amount of time (YES in step SD3), the second estimation unit 352 estimates the second amount of time (step SD4).

Subsequently, the image processing unit 355 determines whether the direction indicator has been operated (step SD5).

When the in-vehicle apparatus 30 receives the data indicating that the direction indicator has been caused to blink, the image processing unit 355 makes a positive determination in step SD5.

When determining that the direction indicator has not been operated (NO in step SD5), the image processing unit 355 starts adding the second-amount-of-time information J3 (step SD6).

With this, the viewer terminal 200B can display, before the vehicle 3 starts turning, the second amount of time along with the image obtained through capturing by the streamer terminal 200A.

The image processing unit 355 determines whether the vehicle 3 has started turning (step SD7). To describe step SD7 in detail, the image processing unit 355 performs the determining of step SD7 based on the detected value from the yaw rate sensor of the sensor group 39.

When determining that the vehicle 3 has not started turning (NO in step SD7), the image processing unit 355 performs the determining of step SD7 once more.

On the other hand, when determining that the vehicle 3 has started turning (YES in step SD7), the image processing unit 355 stops adding the second-amount-of-time information J3 and starts adding the first-amount-of-time information J1 and the turning-in-progress information J2 (step SD8).

With this, the viewer terminal 200B can display the first amount of time and that the vehicle 3 is currently turning along with the image obtained through capturing by the streamer terminal 200A.

Subsequently, the image processing unit 355 determines whether the vehicle 3 has finished turning (step SD9). To describe step SD9 in detail, the image processing unit 355 makes a positive determination in step SD9 based on the detected value from the yaw rate sensor of the sensor group 39.

When determining that the vehicle 3 has not finished turning (NO in step SD9), the image processing unit 355 performs the determining of step SD9 once more.

On the other hand, when determining that the vehicle 3 has finished turning (YES in step SD9), the image processing unit 355 finishes adding the first-amount-of-time information J1 and the turning-in-progress information J2 (step SD10).

Returning to the description of step SD5, when determining that the direction indicator has been operated (YES in step SD5), the image processing unit 355 starts adding the second-amount-of-time information J3 and the arrow image YG (step SD11).

With this, the viewer terminal 200B can display, before the vehicle 3 starts turning, the second amount of time and that the direction indicator has been operated along with the image obtained through capturing by the streamer terminal 200A.

The image processing unit 355 determines whether the vehicle 3 has started turning (step SD12). The determining of step SD12 is performed similarly to the determining of step SD7.

When determining that the vehicle 3 has not started turning (NO in step SD12), the image processing unit 355 performs the determining of step SD12 once more. On the other hand, when determining that the vehicle 3 has started turning (YES in step SD12), the image processing unit 355 stops adding the second-amount-of-time information J3 and starts adding the first-amount-of-time information J1 and the turning-in-progress information J2 (step SD13).

With this, the viewer terminal 200B can display the first amount of time, that the vehicle 3 is currently turning, and that the direction indicator has been operated along with the image obtained through capturing by the streamer terminal 200A.

Subsequently, the image processing unit 355 determines whether the vehicle 3 has finished turning (step SD14). The determining of step SD14 is performed similarly to the determining of step SD9.

When determining that the vehicle 3 has not finished turning (NO in step SD14), the image processing unit 355 performs the determining of step SD14 once more.

On the other hand, when determining that the vehicle 3 has finished turning (YES in step SD14), the image processing unit 355 finishes adding the first-amount-of-time information J1, the turning-in-progress information J2, and the arrow image YG (step SD15).

Next, the operation of the viewer terminal 200B during the output of the streamed content will be described.

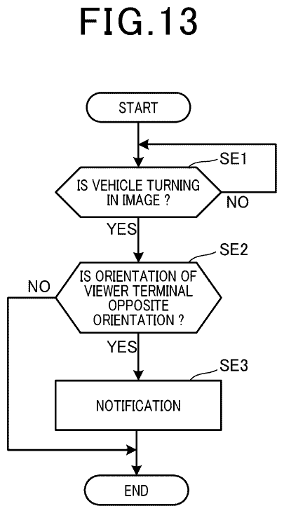

FIG. 13 is a flowchart showing the operation of the viewer terminal 200B.

The operation shown in FIG. 13 is an operation that is repeatedly executed while the viewer terminal 200B is outputting the streamed content.

The third control section 270 determines whether the vehicle 3 is turning in an image displayed by the display 240 (step SE1). In step SE1, the third control section 270 may determine whether the vehicle 3 is turning by performing image analysis (for example, analysis using optical flow) on the image shown on the display 240. In step SE1, the third control section 270 may determine based on whether the display 240 is displaying the first-amount-of-time information J1. In step SE1, the third control section 270 may determine based on whether the display 240 is displaying the turning-in-progress information J2. In step SE1, the third control section 270 may determine whether the vehicle 3 is turning based on the yaw rate of the vehicle 3. Note than when determining whether the vehicle 3 is turning based on the yaw rate, the vehicle 3 transmits the detected value from the yaw rate sensor to the viewer terminal 200B via the streaming server 100, and the viewer terminal 200B determines whether the vehicle 3 is turning based on the received detected value from the yaw rate sensor.

When determining that the vehicle 3 is not turning (NO in step SE1), the third control section 270 performs the determining of step SE1 once more.

When determining that the vehicle 3 is turning (YES in step SE1), the third control section 270 determines, based on the detected value from the motion sensor 230, whether the orientation of the viewer terminal 200B is opposite to a direction in which the vehicle 3 is turning in the displayed image (step SE2). In step SE2, the third control section 270 detects the direction in which the vehicle 3 is turning and determines whether the orientation of the viewer terminal 200B is an opposite direction, by performing image analysis on the image shown on the display 240. For example, when the vehicle 3 is turning to the right and the orientation of the viewer terminal 200B is to the left in the image shown on the display 240, the third control section 270 makes a positive determination in step SE2. For example, when the vehicle 3 is turning to the left and the orientation of the viewer terminal 200B is to the left in the image shown on the display 240, the third control section 270 makes a negative determination in step SE2.

When determining that the orientation of the viewer terminal 200B is not opposite to the direction in which the vehicle 3 is turning (NO in step SE2), the third control section 270 ends the present processing.

On the other hand, when determining that the orientation of the viewer terminal 200B is opposite to the direction in which the vehicle 3 is turning (YES in step SE2), the third control section 270 provides a notification encouraging to look in the direction in which the vehicle 3 is turning (step SE3).

The notification of step SE3 may be provided on the display 240 or via the speaker 260.

Note that in the flowchart shown in FIG. 13, the processing ends when making the negative determination in step SE2 or when providing the notification in step SE3. However, when making the negative determination in step SE2 or when providing the notification in step SE3, the third control section 270 may determine whether the vehicle 3 has finished turning, end the processing when determining that the vehicle 3 has finished turning, and start the processing once more from step SE1 when determining that the vehicle 3 has not finished turning.

In this case, the third control section 270 may determine whether the vehicle 3 has finished turning by performing image analysis (for example, analysis using optical flow) on the image shown on the display 240. The third control section 270 may determine whether the vehicle 3 has finished turning, based on whether the display 240 is displaying the first-amount-of-time information J1. The third control section 270 may determine whether the vehicle 3 has finished turning, based on whether the display 240 is displaying the turning-in-progress information J2. The third control section 270 may determine whether the vehicle 3 has finished turning, based on the yaw rate of the vehicle 3. When the vehicle 3 has been traveling straight for a certain period of time (for example, 0.5 to 5 seconds), the third control section 270 may determine that the vehicle 3 has finished turning, based on the image analysis, the yaw rate of the vehicle 3, or the like.

### 2. Second Embodiment

Next, a second embodiment will be described.

In the description of the second embodiment, constituent elements identical to those of each unit of the streaming system 1 of the first embodiment will be denoted by the same reference numerals and detailed description thereof will be omitted as appropriate.

Hereinafter, portions different from the first embodiment will mainly be described.

In the second embodiment, the operation of the image processing unit 355 differs from that in the first embodiment.

While the vehicle 3 is turning, the image processing unit 355 of the second embodiment generates the first composite image CP1 in which an external region A1 of the image acquired from the correction unit 354 is blacked out.

The external region A1 is a region in which an area outside of the vehicle 3 is depicted, and is the windshield portion in FIG. 6, for example.

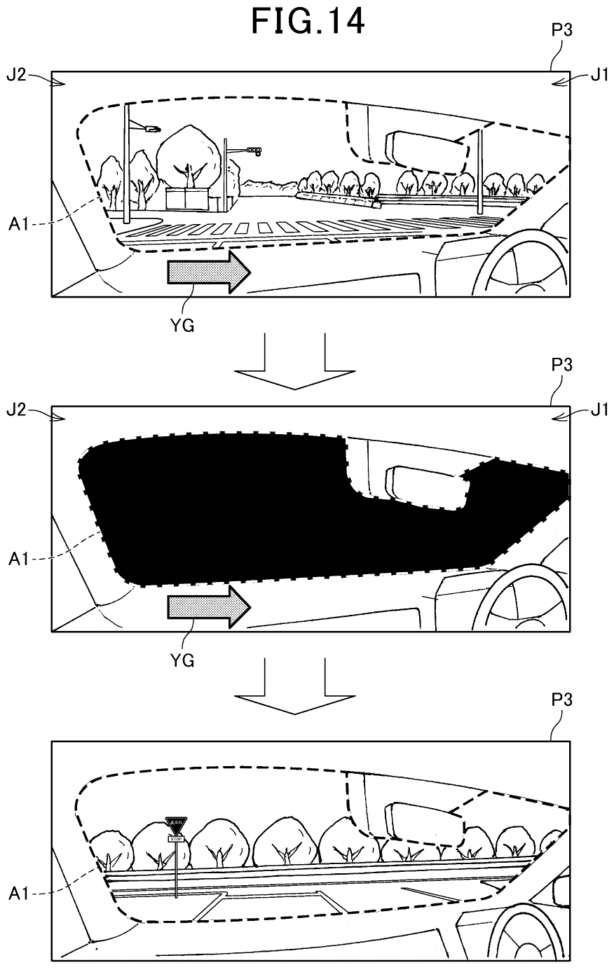

FIG. 14 is a diagram for describing the operation of the image processing unit 355 of the second embodiment.

FIG. 14 exemplifies a case in which the external region A1 of an image P3 is blacked out. The image P3 shown in FIG. 14 is an image captured from the passenger seat of the vehicle 3 and depicts the area in front of the vehicle 3 through the windshield.

An upper part of FIG. 14 shows an image output by the image processing unit 355 to the streaming unit 356 when the vehicle 3 has started turning. A middle part of FIG. 14 shows an image output by the image processing unit 355 to the streaming unit 356 while the vehicle 3 is turning. A lower part of FIG. 14 shows an image output by the image processing unit 355 to the streaming unit 356 when the vehicle 3 has finished turning. Note that dashed lines indicating the external region A1 and leader lines of the external region A1 are not included in the image output by the image processing unit 355 to the streaming unit 356.

When the vehicle 3 starts turning, the image processing unit 355 blacks out the external region A1 of the image P3 as shown from the upper part to the middle part of FIG. 14. Note that the image processing unit 355 may black out the external region A1 in a fade-out manner.

When the vehicle 3 finishes turning, the image processing unit 355 stops blacking out the external region A1 of the image P3 as shown from the middle part to the lower part of FIG. 14. Note that the image processing unit 355 may stop blacking out the external region A1 in a fade-in manner.

In this way, in the second embodiment, it is possible to further suppress visually induced motion sickness experienced by the viewer of the image, since visibility of a region with a large amount of change is reduced in the streamed image while the vehicle 3 is turning.

### 3. Other Embodiments

Each of the above-described embodiments indicates merely one aspect and can be freely modified and applied.

In the above-described embodiments, the direction indicator having been operated is indicated by the arrow image YG. In another embodiment, the direction indicator having been operated may be indicated in a manner other than the arrow image YG. For example, in the other embodiment, the direction indicator having been operated may be indicated by text such as “turn signal has been operated.”

In the above-described second embodiment, the external region A1 is blacked out. In another embodiment, a brightness of the external region A1 may be lower than when the vehicle 3 is not turning. More specifically, in the other embodiment, the brightness of the external region A1 may be lower than when the first-amount-of-time information J1 has not been added. The same effects as in the second embodiment are achieved in this case as well.

In another embodiment related to the above-described second embodiment, the turning-in-progress information J2 and the arrow image YG need not be displayed.

In the above-described embodiments, the first-amount-of-time information J1 starts being added when the vehicle 3 starts turning, but a timing thereof is not limited thereto, and the first-amount-of-time information J1 may start being added before the vehicle 3 starts turning.

In the above-described embodiments, the in-vehicle apparatus 30 adds the first-amount-of-time information J1, the turning-in-progress information J2, the second-amount-of-time information J3, and the arrow image YG to the image to be streamed. In another embodiment, the streaming server 100 may add the first-amount-of-time information J1, the turning-in-progress information J2, the second-amount-of-time information J3, and the arrow image YG. In the case of this configuration, the streaming server 100 receives, from the in-vehicle apparatus 30, information necessary for the adding, such as the current position of the vehicle 3 and the detected values from the sensor group 39. In the case of this configuration, the second processor 150 functions as the first estimation unit 351, the second estimation unit 352, and the image processing unit 355. The streaming server 100 adds various information to the image streamed from the in-vehicle apparatus 30 and streams the image to the viewer terminal 200B. In this other embodiment, the streaming server 100 may black out the external region A1. In this other embodiment, the second processor 150 may function as the determination unit 353 and the correction unit 354.

In the above-described embodiments, the in-vehicle apparatus 30 adds the first-amount-of-time information J1, the turning-in-progress information J2, the second-amount-of-time information J3, and the arrow image YG to the image to be streamed. In another embodiment, the viewer terminal 200B may add the first-amount-of-time information J1, the turning-in-progress information J2, the second-amount-of-time information J3, and the arrow image YG. In the case of this configuration, the viewer terminal 200B receives, from the in-vehicle apparatus 30 via the streaming server 100, the information necessary for the adding, such as the current position of the vehicle 3 and the detected values from the sensor group 39. In the case of this configuration, the third processor 290 functions as the first estimation unit 351, the second estimation unit 352, and the image processing unit 355. The viewer terminal 200B adds various information to the image streamed from the in-vehicle apparatus 30 and outputs the content. In this other embodiment, the viewer terminal 200B may black out the external region A1. In this other embodiment, the third processor 290 may function as the determination unit 353 and the correction unit 354.

In the above-described embodiment, the streaming unit 356 of the in-vehicle apparatus 30 uploads the content data to the streaming server 100 via the external communication I/F 31. In another embodiment, the streamer terminal 200A may upload the content data to the streaming server 100. More specifically, in this case, the streamer terminal 200A uploads, to the streaming server 100, the content data including the image captured by the camera included in the streamer terminal 200A and the speech input via the microphone included in the streamer terminal 200A.

The configuration of each unit of the streaming system 1 shown in FIGS. 4 and 10 is merely an example, and a specific implementation form thereof is not particularly limited. In other words, it is not necessarily required that separate pieces of hardware be provided for the respective components, and the functions of the respective components may be realized by a single processor executing a program. Some functions realized by software in the above-described embodiment may be realized by hardware, or alternatively, some functions realized by hardware may be realized by software.

The step units of the operations shown in FIGS. 11, 12 and 13 are divided in accordance with their main processing content, and the present invention is not limited by the manner in which the processing units are divided or by the names assigned to those processing units. One step unit may be divided into a greater number of step units in accordance with the processing content. One step unit may be divided so as to include a greater amount of processing. The order of these steps may be rearranged as appropriate so as not to impede the gist of the present invention.

### 4. Configurations Supported by Above Embodiment

The above embodiment supports the following configurations.

### Configuration 1

A streaming system including: a streaming unit configured to stream an image obtained through capturing by a capturing apparatus provided in a vehicle; a display apparatus provided in a location other than the vehicle and configured to display the image streamed by the streaming unit; and a first estimation unit configured to estimate a first amount of time from when the vehicle starts turning until the vehicle finishes turning, based on information of a surrounding area of the vehicle, wherein the display apparatus displays the first amount of time estimated by the first estimation unit along with the image streamed by the streaming unit.

According to the streaming system of configuration 1, a viewer of the image is capable of knowing how much time it takes for the vehicle to finish turning. Therefore, the viewer of the image can appropriately take measures such as not looking at the image, when the vehicle is turning. Thus, it is possible to suppress visually induced motion sickness experienced by the viewer of the image.

### Configuration 2

The streaming system according to configuration 1, wherein when a direction indicator of the vehicle is operated, the display apparatus displays that the direction indicator has been operated.

According to the streaming system of configuration 2, the viewer of the image is capable of knowing that the vehicle 3 is about to turn, since it is displayed that the direction indicator has been operated. Therefore, the viewer of the image can easily take measures such as not looking at the image, when the vehicle is turning. Thus, it is possible to further suppress visually induced motion sickness experienced by the viewer of the image.

### Configuration 3

The streaming system according to configuration 1 or 2, wherein while the vehicle is turning, the display apparatus displays that the vehicle is currently turning.

According to the streaming system 1 of configuration 3, the viewer is capable of easily knowing the reason for a large amount of change in the viewed image, since it is displayed that the vehicle is currently turning. It is possible to prevent a situation in which the viewer stops viewing due to the large amount of change in the image, since the viewer is capable of knowing that the amount of change in the image is large because the vehicle is currently turning.

### Configuration 4

The streaming system according to any one of configurations 1 to 3, including: a second estimation unit configured to estimate a second amount of time until the vehicle starts turning, based on map information of the surrounding area of the vehicle or an image obtained through an external camera provided on the vehicle and configured to capture an area outside of the vehicle, wherein before the vehicle starts turning, the display apparatus displays the second amount of time estimated by the second estimation unit.

According to the streaming system of configuration 4, the viewer of the image is capable of easily knowing when the vehicle starts turning. Therefore, the viewer of the image can easily take measures such as not looking at the streamed image, when the vehicle is turning. Thus, it is possible to further suppress visually induced motion sickness experienced by the viewer of the image.

### Configuration 5

The streaming system according to any one of configurations 1 to 4, wherein the capturing apparatus is provided inside of the vehicle, the image includes an external region depicting an area outside of the vehicle, and while the vehicle is turning, the display apparatus displays the image in which a brightness of the external region is lower than when the vehicle is not turning or the image in which the external region is blacked out.

According to the streaming system of configuration 5, it is possible to further suppress visually induced motion sickness experienced by the viewer of the image, since visibility of a region with a large amount of change is reduced in the streamed image while the vehicle is turning.

### Configuration 6

The streaming system according to any one of configurations 1 to 5, wherein the display apparatus is a head-mounted display apparatus, and when an orientation of the display apparatus changes to an opposite direction to a direction in which the vehicle is turning in the image, the display apparatus outputs a notification encouraging to look in the direction in which the vehicle is turning.

According to the streaming system 1 of configuration 6, it is possible to suppress visually induced motion sickness experienced by the viewer of the image, even when the viewer views the image on the head-mounted display apparatus.

### Configuration 7

The streaming system according to any one of configurations 1 to 6, including: a determination unit configured to determine whether an irregularity is present in a road surface of a road on which the vehicle is traveling; and a correction unit configured to correct blurring in the image, when the determination unit determines that an irregularity is present, wherein the streaming unit streams the image corrected by the correction unit.

According to the streaming system of configuration 7, it is possible to further suppress visually induced motion sickness experienced by the viewer of the image, since the image in which blurring has been corrected is streamed.

### Configuration 8

A non-transitory computer readable storage medium storing a program for causing a processor of a display apparatus to execute: displaying an image obtained through capturing by a capturing apparatus provided in a vehicle; and displaying, along with the image, a first amount of time from when the vehicle starts turning until the vehicle finishes turning, the first amount of time being estimated based on information of a surrounding area of the vehicle.

According to the storage medium of configuration 8, it is possible to achieve the same effects as the streaming system of configuration 1.

### Configuration 9

A streaming method including: a streaming step of streaming an image obtained through capturing by a capturing apparatus provided in a vehicle; a display step of displaying, by a display apparatus, the image streamed in the streaming step; and an estimation step of estimating a first amount of time from when the vehicle starts turning until the vehicle finishes turning, based on information of a surrounding area of the vehicle, wherein the display step includes displaying the first amount of time estimated in the estimation step along with the image streamed in the streaming step.

According to the streaming method of configuration 9, it is possible to achieve the same effects as the streaming system of configuration 1.

### REFERENCE SIGNS LIST

1 streaming system
5 communication network
10 seat
11 backrest
12 headrest
13 headrest stay
30 in-vehicle apparatus
31 external communication I/F
32 first short-range wireless communication I/F
33 internal communication I/F
34 touch panel
35 speech processing unit
36 speaker
37 external camera
38 turn signal switch
39 sensor group
40 vehicle ECU
50 attachment
51 first holder
100 streaming server
110 network communication I/F
130 second control section
140 second memory
141 control program
143 user information database
145 stream management database
150 second processor
200A streamer terminal (capturing apparatus)
200B viewer terminal (display apparatus)
210 wireless communication I/F
220 second short-range wireless communication I/F
230 motion sensor
240 display
250 microphone
260 speaker
270 third control section
280 third memory
281 OS
283 APP (program)
290 third processor (processor)
310 input/output I/F
330 first control section
340 first memory
345 control program
346 map data
350 first processor
351 first estimation unit
352 second estimation unit
353 determination unit
354 correction unit
355 image processing unit
356 streaming unit
A1 external region
CP1 first composite image
CP2 second composite image
J1 first-amount-of-time information
J2 turning-in-progress information
J3 second-amount-of-time information
P1 to P3 image
S streamer
SA3 streaming step
SC3 display step
SD2 estimation step
U viewer
YG arrow image

1. A streaming system comprising:
a streaming unit configured to stream an image obtained through capturing by a capturing apparatus provided in a vehicle;
a display apparatus provided in a location other than the vehicle and configured to display the image streamed by the streaming unit; and
a first estimation unit configured to estimate a first amount of time from when the vehicle starts turning until the vehicle finishes turning, based on information of a surrounding area of the vehicle, wherein
the display apparatus displays the first amount of time estimated by the first estimation unit along with the image streamed by the streaming unit.

2. The streaming system according to claim 1, wherein
when a direction indicator of the vehicle is operated, the display apparatus displays that the direction indicator has been operated.

3. The streaming system according to claim 1, wherein while the vehicle is turning, the display apparatus displays that the vehicle is currently turning.

4. The streaming system according to claim 1, comprising:
a second estimation unit configured to estimate a second amount of time until the vehicle starts turning, based on map information of the surrounding area of the vehicle or an image obtained through an external camera provided on the vehicle and configured to capture an area outside of the vehicle, wherein
before the vehicle starts turning, the display apparatus displays the second amount of time estimated by the second estimation unit.

5. The streaming system according to claim 1, wherein
the capturing apparatus is provided inside of the vehicle,
the image includes an external region depicting an area outside of the vehicle, and
while the vehicle is turning, the display apparatus displays the image in which a brightness of the external region is lower than when the vehicle is not turning or the image in which the external region is blacked out.

6. The streaming system according to claim 1, wherein
the display apparatus is a head-mounted display apparatus, and
when the display apparatus faces an opposite direction to a direction in which the vehicle is turning in the image, the display apparatus outputs a notification encouraging to look in the direction in which the vehicle is turning.

7. The streaming system according to claim 1, comprising:
a determination unit configured to determine whether an irregularity is present in a road surface of a road on which the vehicle is traveling; and
a correction unit configured to correct blurring in the image, when the determination unit determines that an irregularity is present, wherein
the streaming unit streams the image corrected by the correction unit.

8. A non-transitory computer readable storage medium storing a program for causing a processor of a display apparatus to execute:
displaying an image obtained through capturing by a capturing apparatus provided in a vehicle; and
displaying, along with the image, a first amount of time from when the vehicle starts turning until the vehicle finishes turning, the first amount of time being estimated based on information of a surrounding area of the vehicle.

9. A streaming method comprising:
a streaming step of streaming an image obtained through capturing by a capturing apparatus provided in a vehicle;
a display step of displaying, by a display apparatus, the image streamed in the streaming step; and
an estimation step of estimating a first amount of time from when the vehicle starts turning until the vehicle finishes turning, based on information of a surrounding area of the vehicle, wherein
the display step includes displaying the first amount of time estimated in the estimation step along with the image streamed in the streaming step.
